(19) United States
(12) Patent Application Publication
(10) Pub. No.: US 2020/0364900 A1
(43) Pub. Date: Nov. 19, 2020

(54) POINT MARKING USING VIRTUAL FIDUCIAL ELEMENTS

(71) Applicant: Matterport, Inc., Sunnyvale, CA (US)

(72) Inventors: Gary Bradski, Palo Alto, CA (US); Gholamreza Amayeh, San Jose, CA (US); Mona Fathollahi, Sunnyvale, CA (US); Ethan Rublee, Mountain View, CA (US); Grace Vesom, Woodside, CA (US); William Nguyen, Mountain View, CA (US)

(73) Assignee: Matterport, Inc., Sunnyvale, CA (US)

(21) Appl. No.: 16/412,825

(22) Filed: May 15, 2019

(51) Int. Cl. G06T 7/73; H04N 5/262; H04N 5/247

(52) U.S. Cl. CPC G06T 7/75; G06T 2207/30204; H04N 5/247; H04N 5/2628

(57) ABSTRACT

Systems and methods for point marking using virtual fiducial elements are disclosed. An example method includes placing a set of fiducial elements in a locale or on an object and capturing a set of calibration images using an imager. The set of fiducial elements is fully represented in the set of calibration images. The method also includes generating a three-dimensional geometric model of the set of fiducial elements using the set of calibration images. The method also includes capturing a run time image of the locale or object. The run time image does not include a selected fiducial element, from the set of fiducial elements, which was removed from a location in the locale or on the object prior to capturing the run time image. The method concludes with identifying the location relative to the run time image using the run time image and the three-dimensional geometric model.

### BACKGROUND

Fiducials elements are physical elements placed in the field of view of an imager for purposes of being used as a reference. Geometric information can be derived from images captured by the imager in which the fiducials are present. The fiducials can be rigidly attached to the imager itself such that they are always within the field of view of the imager or placed in a locale so that they are in the field of view of the imager when it is in certain positions within that locale. In the later case, multiple fiducials can be distributed throughout the locale so that fiducials can be within the field of view of the imager as its field of view is swept through the locale. The fiducials can be visible to the naked eye or designed to only be detected by a specialized sensor. Fiducial elements can be simple markings such as strips of tape or specialized markings with encoded information. Examples of fiducial tags with encoded information include AprilTags, QR Barcordes, Aztec, MaxiCode, Data Matrix and ArUco markers.

Fiducials can be used as references for robotic computer vision, image processing, and augmented reality applications. For example, once captured, the fiducials can serve as anchor points for allowing a computer vision system to glean additional information from a captured scene. In a specific example, available algorithms recognize an AprilTag in an image and can determine the pose and location of the tag from the image. If the tag has been “registered” with a locale such that the relative location of the tag in the locale is known a priori, then the derived information can be used to localize other elements in the locale or determine the pose and location of the imager that captured the image.

FIG. 1 shows a fiducial element 100 in detail. The tag holds geometric information in that the corner points 101-104 of the surrounding black square can be identified. Based on prior knowledge of the size of the tag, a computer vision system can take in an image of the tag from a given perspective, and the perspective can be derived therefrom. For example, a visible light camera 105 could capture an image of fiducial element 100 and determine a set of values 106 that include the relative position of four points corresponding to corner points 101-104. From these four points, a computer vision system could determine the perspective angle and distance between camera 105 and tag 100. If the position of tag 100 in a locale were registered, then the position of camera 105 in the locale could also be derived using values 106. Furthermore, the tag holds identity information in that the pattern of white and black squares serves as a two-dimensional bar code in which an identification of the tag, or other information, can be stored. Returning to the example of FIG. 1, the values 106 could include a registered identification “TagOne” for tag 100. As such, multiple registered tags distributed through a locale can allow a computer vision processing system to identify individual tags and determine the position of an imager in the locale even if some of the tags are temporarily occluded or are otherwise out of the field of view of the imager.

FIG. 1 further includes a subject 110 in a set 111. As illustrated, fiducial elements 112 and 113 have been placed in set 111 to serve as references for facilitating the kinds of image processing techniques mentioned above. However, as the tags have been captured along with the scene, they will need to be removed via post processing before the scene is in final form. Furthermore, if set 111 is being used for a live performance, the presence of the tags could appear unprofessional and be distracting for the audience. Physically removing the tags for live camera shoots is also a possibility, but then the tags cannot be used during the live shoot.

### SUMMARY

This disclosure includes systems and methods for point marking using virtual fiducial elements. The virtual fiducial elements can be data entries in a three-dimensional model. The three-dimensional model can be generated through the imaging of a calibration set of fiducial elements. The fiducial elements in the calibration set can be traditional fiducials, such as AprilTags, or any registered visual features as described in U.S. patent application Ser. No. 16/412,784, filed concurrently herewith, which is incorporated by reference herein in its entirety for all purposes. The calibration set of fiducial elements can comprise temporary fiducial elements and anchor fiducial elements. The virtual fiducial elements can be generated via the capture of the temporary fiducial at a set of specific locations, the generation of a three-dimensional model of that capture, and the subsequent removal of the temporary fiducial elements from those specific locations. In specific embodiments of the invention, the anchor fiducial elements, three-dimensional model, and virtual fiducial elements can subsequently be used for point marking any of the computer vision, robotics, and augmented reality applications mentioned above.

The calibration fiducial elements can be placed in a locale for capture by an imager operating in that locale. Locales in which the fiducial elements can be placed include a set, playing field, race track, stage, or any other locale in which an imager will operate to capture data inclusive of the data embodied by the fiducial element. The locale can include a subject to be captured by the imager along with the fiducial elements. The locale can host a scene that will play out in the locale and be captured by the imager along with the fiducial elements. The fiducial elements can also be deployed on a given subject as a fiducial element for capture by an imager serving to follow that subject. For example, the fiducial elements could be on the clothes of a human subject, attached to the surface of a vehicular subject, or otherwise attached to a mobile or stationary subject.

In specific embodiments of the invention, the temporary fiducial elements can be in a key region of the locale or on a key portion of the subject. The virtual fiducial elements can be generated by capturing the locale or subject with the temporary fiducial elements located in the key region of the locale or on the key portion of the subject. Subsequently, the temporary fiducial elements can be removed such that the key region or portion is devoid of physical fiducial elements. The key region or portion can be a part of the capture in which fiducial elements would appear undesirable such as on the stage of a live performance or broadcast. In accordance with specific embodiments of the invention, virtual fiducial elements can allow for point marking without the need for distracting fiducial elements to be placed at key portions of the locale or on the subject.

In a specific embodiment of the invention a method is provided. The method includes placing a set of fiducial elements in a locale or on an object and capturing a set of calibration images using an imager. The set of fiducial elements is fully represented in the set of calibration images. A selected fiducial element in the set of fiducial elements is in a location. The method also includes generating a three-dimensional geometric model of the set of fiducial elements, using the set of calibration images, and capturing a run time image of the locale or object. The run time image does not include the selected fiducial element. The method also includes identifying the location relative to the run time image using the run time image and the three-dimensional geometric model.

In a specific embodiment of the invention a method is disclosed. The method comprises placing a set of fiducial elements in a locale or on an object and capturing a set of calibration images using an imager. The set of fiducial elements is fully represented in the set of calibration images. The set of fiducial elements includes a set of anchor fiducial elements and a set of temporary fiducial elements. The method also comprises generating a three-dimensional geometric model of the set of fiducial elements using the set of calibration images, removing the set of temporary fiducial elements from the locale or object, and capturing, after removing the set of temporary fiducial elements, a second image of the locale or object. The second image includes at least one anchor fiducial element from the set of anchor fiducial elements. The method also includes identifying a set of locations previously occupied by the set of temporary fiducial elements using the second image and the three-dimensional geometric model.

In a specific embodiment of the invention a method is disclosed. The method includes placing a set of fiducial elements in a locale or on an object. The method also includes capturing a set of calibration images using an imager. The set of fiducial elements is fully represented in the set of calibration images. A selected fiducial element in the set of fiducial elements is in a location. The method also includes generating a three-dimensional geometric model of the set of fiducial elements using the set of calibration images. The method also includes capturing, after generating the three-dimensional geometric model, a run time image of the locale or object. The run time image does not include the selected fiducial element because the selected fiducial element is occluded. The method also includes identifying the location relative to the run time image using the run time image and the three-dimensional geometric model.

### BRIEF DESCRIPTION OF THE DRAWINGS

FIG. 1 is an illustration of a locale with fiducial elements in accordance with the related art.

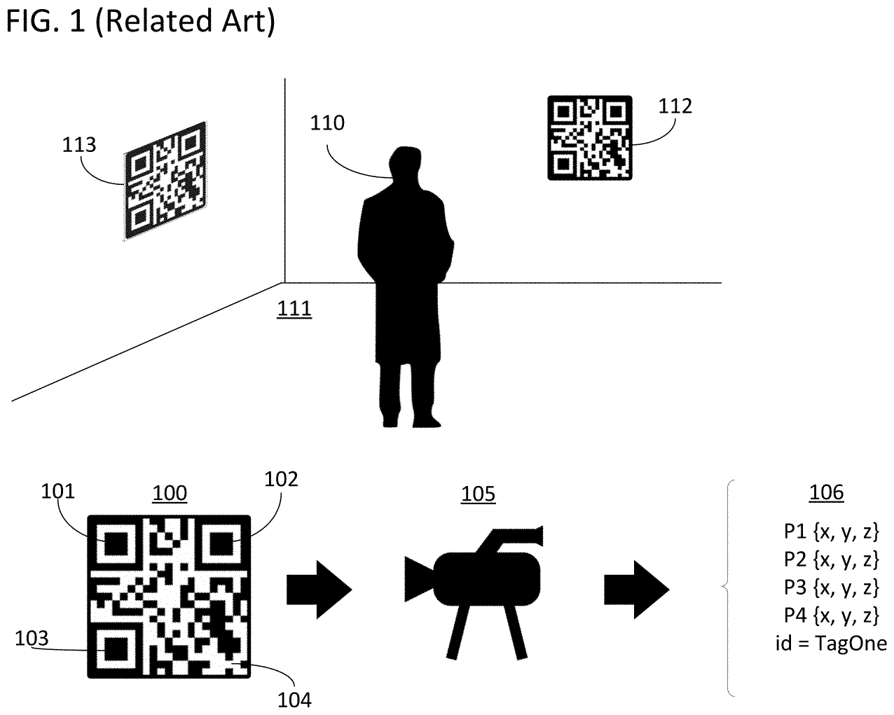

FIG. 2 is a flow chart of a set of methods for registering and deploying virtual fiducial elements in accordance with specific embodiments of the invention.

FIG. 3 is an illustration of a locale with a calibration set of fiducial elements and the capture of a three-dimensional model therefrom in accordance with specific embodiments of the invention.

FIG. 4 is an illustration of the locale of FIG. 3 in which the temporary fiducial elements from the calibration set have been removed, while the three-dimensional model, set of anchor fiducial elements, and virtual fiducial elements are used for point marking.

FIG. 5 is a photograph of a locale that has been augmented to include the location of a set of virtual fiducial elements located therein in accordance with specific embodiments of the invention.

### DETAILED DESCRIPTION

Specific methods and systems associated with visual features in accordance with the summary above are provided in this section. The methods and systems disclosed in this section are non-limiting embodiments of the invention, are provided for explanatory purposes only, and should not be used to constrict the full scope of the invention.

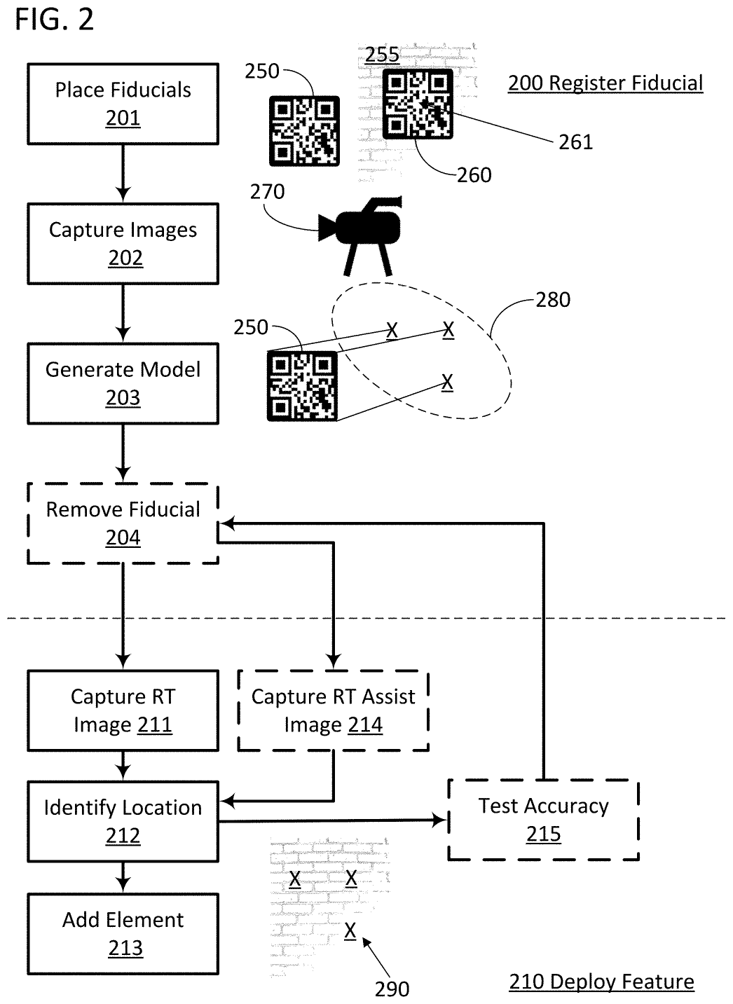

FIG. 2 illustrates a flow chart for a set of methods that are in accordance with specific embodiments of the invention. The flow chart includes a first section 200 in which a virtual fiducial is registered for use as a fiducial element and a second section 210 in which the virtual fiducial is deployed for such use. The flow chart includes the example of a virtual fiducial being registered through the use of a temporary fiducial element in the form of an AprilTag 250 in the immediate proximity of an anchor fiducial element in the form of an AprilTag 260. The virtual fiducial can be registered through the use of a captured set of images that can be referred to as a calibration set of images. The set can include a single image. The virtual fiducial can subsequently be deployed and utilized during the capturing of a set of images that can be referred to as a set of run time images. The set of run time images can be used to form a set of scene images for consumption by a viewer. The term temporary fiducial refers to a fiducial that will be placed during a calibration capture but will be removed prior to the run time capture. The term anchor fiducial refers to a fiducial that will be placed during both a calibration capture and a run time capture. The approaches disclosed herein can be used with a broad array of fiducial elements in various combinations. For example, the temporary and anchor fiducial elements do not need to both be the same type of fiducial element as in FIG. 2.

Flow chart section 200 being with a step 201 of placing a set of fiducial elements in a locale or on an object. In the illustrated case, this involves placing fiducials in the form of AprilTag 250 and AprilTag 260 in a locale on which a scene will be captured. In the figure, the locale is represented by a brick wall 255. AprilTag 260 is located at a location 261, can be an on-stage fiducial element, can be referred to herein as a “first fiducial element” to distinguish it and others like it from AprilTag 250, and can also be referred to as a “selected fiducial element” because in certain embodiments it will be selected for removal from the locale as described below in more detail. In other words, the fiducial elements in the set of calibration fiducial elements that will be removed prior to run time are not necessarily known when the calibration set of images is first captured. AprilTag 250, can be an off-stage fiducial element, and can be referred to as a “second fiducial element.” The fiducial elements can be placed in the scene in such a way that they will be readily captured along with the contents of the locale or object. For example, AprilTags can be placed in a local by being attached to walls, placed on flat surfaces, attached to stands, suspended from ceilings, or attached to specialized rigging equipment. As another example, AprilTags, or other encodings, can be integrated into the clothing of a subject in a scene. As described in U.S. patent application Ser. No. 16/412,784, placing a fiducial element might not require an active effort by any party in that the fiducial element may already be a natural element of the locale or subject.

The fiducial elements can be placed in a locale or on a subject with an eye towards allowing a subset of fiducials to be captured at run time while another subset of fiducials are either occluded or have been removed. The placement of the fiducial elements can also depend on the nature of the elements and the locale or subject on which they will be placed. The locale can be a studio, set, performance venue, sports field, or race track. The fiducial elements could be two dimensional encodings that would appear unprofessional or distracting if they were required to be placed in the locale during run time. However, a portion of the locale could be out of the main field of view of the imager tasked with capturing the scene or the audience viewing the local. For example, the locale could include an on-stage portion and an off-stage portion. The on-stage portion could be where the performers of other subjects of a live event are located in order for them to be seen by a live audience. The on-stage portion could also be the portion of a studio in which a scene is meant to be captured. The set of fiducials that are meant to be captured at run time, if any, could be located in the off-stage portion of the locale while the temporary fiducials are located in the on-stage portion of the locale.

The fiducial elements can also be placed with an understanding that not all of the fiducial elements will be visible to an imager at all times during run time capture, not because they have been removed, but because they have been occluded. For example, if point marking is being used for post processing to identify the point at which a virtual light source is being added to a captured scene, and an object in the scene temporarily eclipses the source of light, post processing will still need to keep track of the occluded point for purposes of determining the effect of lighting on alternative portions of the scene that are visible in a given run time image. In these situations, the fiducials can be distributed throughout the scene so that different subsets can be viewed regardless of the location of the imager relative to natural obstructions in the locale or the known paths of occluding objects that will move through the scene, such as the movement of actors through a set.

Regardless of whether specific fiducials will be absent because they are temporary elements meant to be removed from the scene, or because of the a priori expectation of occlusions, care must be taken regarding the placement of the fiducials in order to assure that enough fiducial elements remain to be captured. In specific embodiments of the invention, the placing step will be conducted such that, regardless of the occurrence of expected occlusions in the scene, a set of at least four non-colinear and non-coplanar fiducial elements will always be within view of an imager capturing the scene during run time. This set can comprise anchor fiducials or a set of fiducials that will be visible from a given pose, zoom, and time point during the execution of a scene in a given locale or including a given subject. In situations in which the movement of potential occlusions, or trajectory of the imager, through the scene is not known a priori, a larger amount of fiducial elements can be added to assure this target is met. In situations in which the locale includes an on-stage and off-stage section, the placing step can be conducted such that the set of anchor fiducial elements surround the set of temporary fiducial elements on at least two sides. For example, the temporary fiducial elements could be gathered on a stage while the anchor fiducial elements were suspended above, and to the side of the stage. The resulting configuration of fiducial elements has been found to be sufficient for accurately point marking the former location of temporary fiducials located in the on-stage section. Furthermore, the placing step can be conducted such that the anchor fiducial elements are visible from a zoomed-out view of any portion of the scene while a zoomed in view, captured from the same pose, does not include the anchor fiducial elements.

Flow chart section 200 continues with a step 202 of capturing a set of calibration images using an imager. The set of fiducial elements can be fully represented in the set of calibration images meaning that each fiducial element in the set is operatively visible in at least one image in the set of calibration images. Operative visibility can be defined with reference to the type of fiducial being used and refers to the ability to extract from an image all the physical geometric and/or encoded information offered by the fiducial. The step of capturing the calibration images can be specifically conducted for purposes of ensuring that all the fiducial elements are included in at least one of the images to make sure that all the fiducial elements in the set are fully represented.

Step 202 can be conducted using a variety of imagers. This step can involve the use of a visible light camera, a multi-camera stereo rig, a wide angle (including full 360 degree) camera, an infrared or ultraviolet imager, a depth sensor, or any other device capable of capturing images of fiducial elements. The images can accordingly by two-dimensional visible light texture maps, 2.5-dimensional texture maps with depth values, or full three-dimensional point cloud images of the scene or object. The images can also be pure depth maps without texture information, surface maps, normal maps, or any other kind of image based on the application and the type of imager applied to capture the images. The imager can be swept through the locale or around the object to capture the calibration images. Step 202 can be conducted such that the relationship of the multiple images in terms of the location, pose, and zoom of the imager can be derived for each image independently or relative to the remaining images. The imager can include an Inertial Measurement Unit (IMU) or other location tracker for purposes of capturing this information along with the images. Furthermore, certain approaches such as Simultaneous Localization and Mapping (SLAM) can be used by the imager to localize itself as it captures the calibration images in step 202. Regardless of the specific approach that is utilized, the derived information can be used in step 203 in combination with the images to generate the model as described in the following paragraph. In FIG. 2 step 202 would involve the basic capture of a visible light image of fiducial 250 and 260 in the locale using a visible light camera 270. However, this is a trivial example relative to the common applications of the disclosed embodiments and more complex captures can be required. As illustrated, AprilTag 260 is in location 261 when the calibration images are captured.

Flow chart section 200 includes a step 203 of generating a three-dimensional geometric model of the set of fiducial elements using the set of calibration images captured in step 202. The geometric model can be a description of the relative positions of the fiducial elements in three-dimensional space relative to each other. The data for the geometric model can be stored either in the memory of an imager that captured the images, on a server in which the calibration images are stored and can be operated on, or in some other computer-readable media. The manner in which the model is generated will depend on the characteristics of the calibration images. In situations in which the capturing of the set of calibration images is conducted using a camera and the fiducial elements in the set of fiducial elements comprise two-dimensional encodings, pose information can be derived from the two-dimensional encodings to determine the relative location of the elements in three-dimensional space. If the pose of the calibration imager is also known as it is swept through the scene or around the object, the position of the imager can also be applied to derive the location of the elements. The pose information of the fiducial elements can be used to derive a bundle of pose information which includes pose information for each fiducial element in the set of fiducial elements, and the generating of the three-dimensional geometric mode can use the pose information for a global bundle adjustment for the set of fiducial elements. This approach can be used to minimize the effect of calibration errors or other offsets which may have derived an inaccurate set of position information for one or more of the fiducial elements in the set, where the bundle of pose information serves as a cross check against the relative positions of multiple different combinations of fiducials in the overall set. In specific embodiments, the derived pose information can be used to project a model of the fiducial onto the image using a first system while a second system compares the original image with image having the projected fiducial.

In the illustrated case, the three-dimensional model 280 can be a set of vectors defining the relative position in three-dimensional space between specific points on an anchor tag to specific points on a temporary tag. The model can be multiple sets of vectors defining the location of all fiducial elements in the model from a common element such as in a hub and spoke model. The specific points can be points located on fiducial elements which commonly available computer vision algorithms are programmed to detect and localize. For example, in the illustrated case, the points are the corners of an AprilTag 250 which commonly available computer vision algorithms are programmed to detect. The generation of the model involves storing the three vectors associated with the corners of AprilTag 260 for later use. In specific embodiments of the invention, the three-dimensional model can be derived through alternative means and will not require a capture. For example, the three-dimensional model could be generated by precisely measuring the points at which virtual fiducial elements will be registered relative to fiducial elements which will remain in the scene. Precise measurements could be made from the physical locations occupied by the fiducial elements to those points and the outcome of those measurements could be used to generate a three-dimensional model of the fiducial elements and the virtual fiducial elements.

Flow chart section 210 includes a step 211 of capturing run time images of the locale or subject. However, prior to executing step 211, flow chart section 200 includes an optional step of removing fiducial elements 204. This step can include removing fiducial elements from a locale or from a subject. This step can be conducted after capturing the set of calibration images in step 202 but prior to capturing the run time images in step 211. Although step 204 is shown as being conducted after generating the model in step 203 the exact order of these two steps is not a limitation as either step can be conducted first because the model can be generated based on data stored for later usage. In specific embodiments of the invention, the fiducials removed in step 204 can be any temporary fiducial elements introduced in step 201. For example, in embodiments in which a locale includes an off-stage and an on-stage area, the fiducials removed in step 204 could be the on-stage fiducials. The fiducials could be removed all at once or in an iterative fashion.

Flow chart step 211 includes capturing a run time image of the locale or object. Step 211 can be executed such that it does not include a selected fiducial element that was removed in step 204 such as the temporary fiducial elements. Step 211 can also be executed such that it does not include a fiducial element that has been occluded due to the movement of subjects or the imager. The step can be conducted using the same imager used in step 202 to capture the calibration images. However, the step can also be executed using a different imager entirely.

Flow chart section 210 continues with a step 212 of identifying a location associated with a fiducial element that is not present in the image captured in step 211, but with reference to the image captured in step 211. For example, the step could involve using the three-dimensional model generated in step 203 to identify where in the image captured in step 211 the fiducial element should be located. The identified location could be a set of coordinates on the image itself such as x-coordinates and y-coordinates identifying a pixel, or fractional pixel location in a two-dimensional image. When fiducials are of known size, the 3D locations of the points can be deduced. The location could also be a collection of coordinates in that the fiducial will likely occupy more than just a single point in an image, but a collection of points. The location could be defined by a perspective view of a plane projected onto the run time image. In specific embodiments of the invention, the location will not be in the view of the image, and the location will need to be specified with an offset. The offset could define a change in camera pose that would be needed to encompass the location, and a set of coordinates in which the location would be located if the imager was changed to that pose. The offset could alternatively be provided in the coordinate system of the image, but with a set of coordinates that are not actually visible in the image, such as with an offset of 10 pixels up from the top side of a two-dimensional image.

In specific embodiments of the invention, the execution of step 212 will include identifying an anchor fiducial in the image captured in step 211 to determine a captured location. The step will therefore include a sub-step of identifying a capture location relative to the run time image using the run time image and a second fiducial element in the set of fiducial elements. The captured location can then be used to identify a location associated with the first fiducial element using the three-dimensional model. For example, anchor fiducial 250 could be registered with the three-dimensional model in step 203. In step 212, the anchor fiducial 250 could be identified in the image, and a captured location that has been pre-registered and associated with anchor fiducial could be combined with the model 280 to determine locations 290. In thee embodiments, if the first fiducial and others had been removed the step would comprising identifying a set of locations previously occupied by the set of temporary fiducial elements using the second image and the three-dimensional geometric model.

Once the location of a virtual fiducial element has been identified in step 212, it can be used for any number of computer vision, augmented realty, and robotics applications in which point marking is required. In specific embodiments of the invention, the location can be used to add a virtual element to the run time image captured in step 211 to create a modified scene image in which special effects or other elements have been added. The step can involve adding a visible virtual element to the run time image using the location to generate a modified image. The virtual element can be added to the run time image using the location and an optional offset to allow the element to appear translated from the precise location identified by the virtual fiducial elements. If more than one virtual fiducial element is located in the image, the translation can include three-dimensional projection information provided to the virtual fiducial element as derived from the three-dimensional relationship of the more than one virtual fiducial elements in the image. Once the virtual element has been added, the modified image can be transmitted. Transmitting the image can involve transmitting it to a display located in a user's eyewear for augmented reality applications, transmitting it to a display in the locale for adding visual effects to real time captured sporting event coverage or allowing a director to immediately see a finalized scene image on a display on set, or transmitting it over a network for streaming of a real time entertainment experience on-line. Using the approaches disclosed herein, there is no need for post processing to remove fiducial elements from the real time images while simultaneously, the real time images have easy to utilize hooks for adding elements to the images. In specific embodiments of the invention, all of steps 211, 212, 213, and the transmitting step can be executed as a real time process using the virtual fiducial elements and any anchor fiducials that may have been utilized in the execution of step 212.

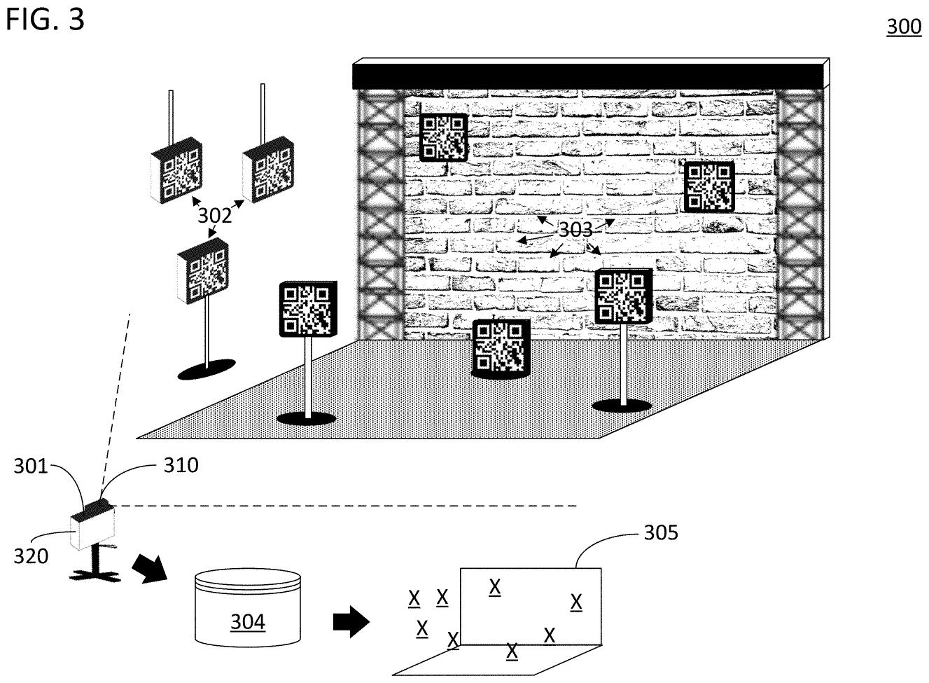

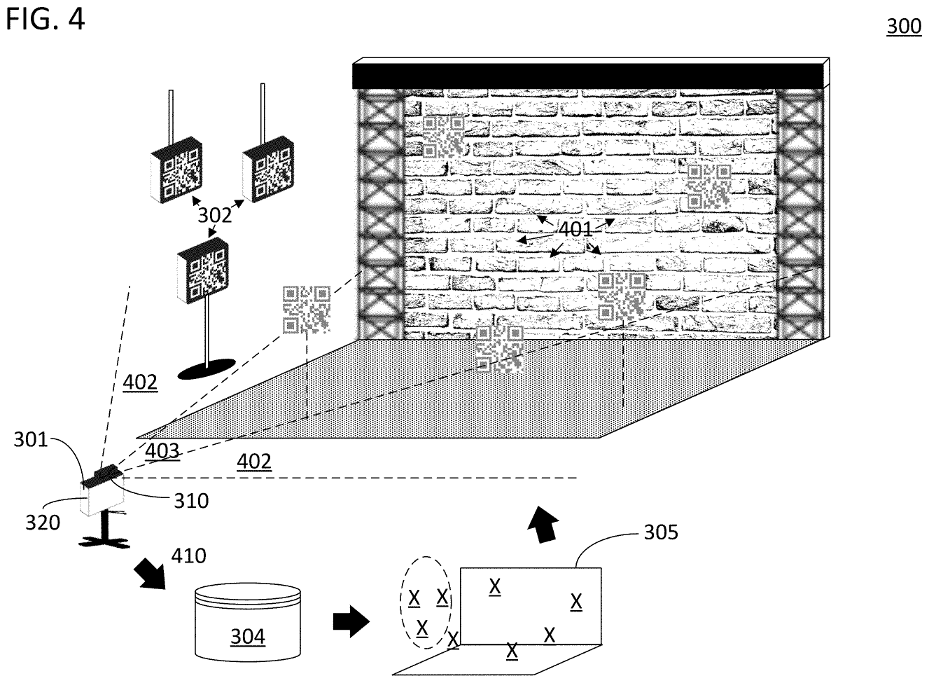

An example execution of the steps of FIG. 2 can be shown with reference to FIGS. 3 and 4. FIGS. 3 and 4 illustrate a locale 300 in the form of a stage on which a scene will be captured by an imager 301. The example is non-limiting in that the same imager is used to both register the virtual fiducial elements and to capture the run time images which will utilize the virtual fiducial elements for point marking. However, different imagers can be used for the two captures. The example is furthermore non-limiting in that the imager 300 includes a witness camera and a hero camera on a shared rig. In these embodiments, the real time image can be captured by the witness camera while a scene image is captured by the hero camera and point marking is conducted on the scene image using the run time image as described below. However, in alternative embodiments, the imager 300 is a single hero camera with a wide-angle view and the scene image is generated from the run time image using a basic post processing crop operation.

FIG. 3 can be used to describe a particular execution of flow chart section 200. As illustrated, step 201 has been executed by placing a set of calibration fiducial elements in the form of AprilTags in locale 300. The set of fiducial elements includes elements that are suspended on holders off the floor, suspended from the sealing, and adhered to flat surfaces in the locale. The set of calibration fiducial elements includes a set of off-stage fiducial elements 302 and a set of on-stage fiducial elements 303. Both sets of fiducial elements are captured by the imager 301 to produce a set of calibration images stored in a memory 304. In the illustrated embodiments, the same imager is used to capture both the calibration images and the run time images associated with steps 202 and 211 described above. In the illustrated embodiments, the stored calibration images are subsequently used in an execution of step 203 to generate a three-dimensional model of the fiducial elements 305 including the on-stage fiducial elements 303 and the off-stage fiducial elements 302. The on-stage fiducial elements 303 can subsequently be removed from the locale 300 as they have been registered and can be deployed as virtual fiducial elements. As such, the off-stage fiducial elements 302 can serve as a set of anchor fiducials while the set of on-stage fiducial elements 303 serve as a set of temporary fiducial elements registered as virtual fiducial elements.

FIG. 4 can be used to describe a particular execution of flow chart section 210. As illustrated, step 204 has been executed by removing the on-stage fiducial elements 303 from locale 300. The fiducial elements have been registered as virtual fiducial elements 401. Subsequently, imager 301 is used to capture an image of the locale 410 and store it in memory 304. The image 410 will include one or more of the off-stage fiducials 302 in the image. The position of those fiducials in the image can then be derived using the position information encoded in the a priori knowledge of the fiducial's characteristics. This position information can then be applied to the three-dimensional model 305 to derive the location of the virtual fiducial elements 401 in image 410 given the location of off-stage fiducials 302 in image 410.

Run time Image 410 can be captured by a hero camera and include off-stage fiducial elements such as fiducial elements 302. For example, imager 301 could be replaced by a wide-angle hero camera with a field of view equal to field of view 402. The point marking facilitated by three-dimensional model 305 could then be used to point mark on the scene image, and can also be used to modify the scene image to include visible virtual elements located at the identified points. Subsequently, the real time image could undergo a post processing step to generate a scene image. The post processing could include a simple cropping step to change the effective field of view of the scene image to be equal to field of view 403. The point marking will therefore have been conducted directly on the image that will be used to produce the scene image. In these embodiments, the run time image includes the off-stage fiducial element, and the identifying step 212 utilizes the run time image, the off-stage fiducial elements, and the three-dimensional model.

Run time image 410 can alternatively be captured by a hero camera with a narrower field of view 403 while a runtime assistance image is captured by a witness camera with a wider field of view 402. In other similar embodiments, a hero camera might be focused on the center of a scene while bolted witness camera(s) look up, down, to the side to capture off-stage fiducials on the ceiling/floor side walls. Regardless, the witness cameras can be extrinsically calibrated to the main camera either explicitly with a fiducial element that both can see in their field of view. The capture of the runtime assistance image is accordingly illustrated as an optional step 214 in FIG. 2 because of the ability of the alternative embodiments described in the prior paragraph. The runtime assistance image can include the off-stage fiducial elements 302. In particular, imager 301 could include a wide-angle witness camera 310 with a field of view that includes anchor fiducials 302, and a hero camera 320 with a field of view that does not include the anchor fiducials. Using approaches in accordance with FIG. 4 in which the witness camera includes more information than the hero camera, the step of capturing an image in step 211 can include the witness camera capturing the run time assistance image and the hero camera capturing a run time image. In these embodiments, the field of view of the witness camera can be registered with the field of view of the hero camera and the two cameras can be attached to a common rigging. Accordingly, when the location of a virtual fiducial is identified in the run time assistance image, a translation into the field of view of the run time image can be easily conducted such that the narrower field of view image can still effectively have access to virtual fiducial elements 401 and be point marked without any fiducials elements actually being captured by the imager that captured the run time image. The run time image can be a scene image captured by the hero camera and the identifying of the location relative to the run time image in step 212 can use the run time assistance image, the run time image, the off-stage fiducial 302, and the three-dimensional model 305.

Flow chart 200 includes an alternative feedback path 215 in which the accuracy of the location identifier is tested, and additional fiducials are removed. Generally, enough fiducials should remain in the locale or on the subject to tack down the three-dimensional model and provide enough of a link between the virtual fiducial elements and the real world locale or subject. The testing of the accuracy of the identifying step can be conducted with a specialized virtual fiducial whose position in the real time image captured in each iteration of the feedback process is known through physical measurement. This process allows an iterative execution of step 204, 211, 212, and 215 until a sufficient subset of fiducial elements from the set of fiducial elements in the locale or on the object remain. The sufficient subset will depend on the degree of accuracy required for a given application. However, the number of remaining fiducial elements should generally be enough so that on the order of four non-planar non-collinear fiducial elements can be located in any real time image that will be used for point marking regardless of the movement of the imager through a local or the movement of potentially occluding objects through the source of a scene capture.

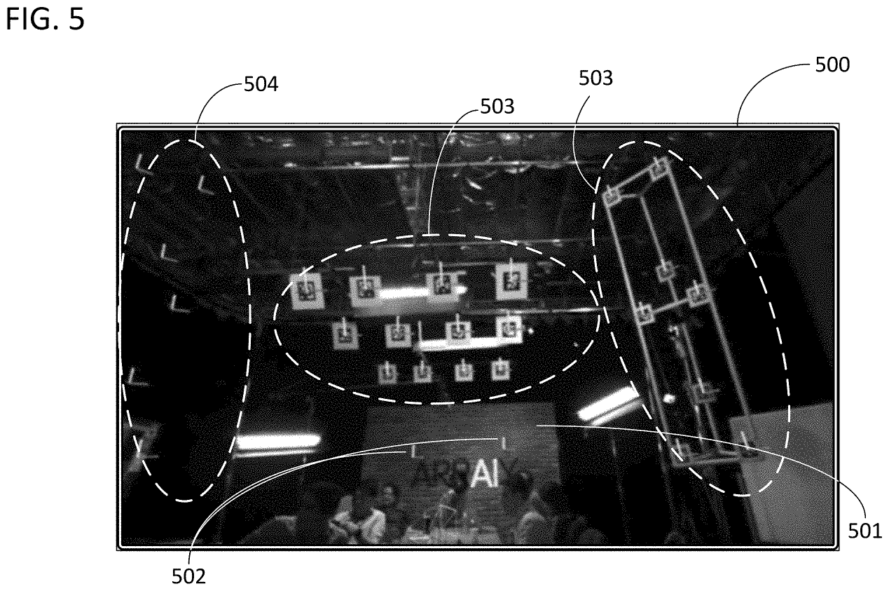

FIG. 5 is an actual scene image 500 produced using an implementation of the flow chart sections of FIG. 2 that would be produced after the execution of step 212. The visible elements that have been added via the execution of step 212 are industry standard three-dimensional axes markers which have been placed using point marking afforded by the virtual fiducial elements. The locale in this case is a set with a table and a brick wall 501. The set includes two axes markers 502 located on the brick wall 501. The locale also includes two sets of anchor fiducials 503 which surround the set of virtual fiducials on two sides. In accordance with the disclosure above, a capture of these anchor fiducials has been used in combination with a three-dimensional model in order to point mark the locations associated with the virtual fiducial elements in image 500. The logo on the brick wall “ARRAIY” has been added to the image via post processing using the point marking provided by the virtual fiducial elements associated with axes markers 502 and is not physically present on the set 500.

The locale in FIG. 5 also includes another set of virtual fiducial elements represented by a set of axes markers 504 that are off-stage. This set of virtual fiducial elements were initially anchor fiducials, but technical staging requirements necessitated the removal of the riggings that held them in place. Regardless, the embodiment of the disclosed invention utilized to generate image 500 functioned sufficiently with those anchor fiducials removed in additional iterations of step 204 such that the anchor fiducials only needed to be placed on two sides of the on-stage virtual fiducial elements.

While the specification has been described in detail with respect to specific embodiments of the invention, it will be appreciated that those skilled in the art, upon attaining an understanding of the foregoing, may readily conceive of alterations to, variations of, and equivalents to these embodiments. While the example of a visible light camera was used throughout this disclosure to describe how a frame is captured, any sensor can function in its place to capture a frame including depth sensors without any visible light capture in accordance with specific embodiments of the invention. Any of the method steps discussed above, with the exception of the placing and removing steps which involve physical manipulations of fiducial elements object, can be conducted by a processor operating with a computer-readable non-transitory medium storing instructions for those method steps. The computer-readable medium may be memory within a personal user device or a network accessible memory. Modifications and variations to the present invention may be practiced by those skilled in the art, without departing from the scope of the present invention, which is more particularly set forth in the appended claims.

1. A method comprising:
placing a set of fiducial elements in a locale or on an object;
capturing a set of calibration images using an imager, wherein the set of fiducial elements is fully represented in the set of calibration images, and wherein a selected fiducial element in the set of fiducial elements is in a location;
generating a three-dimensional geometric model of the set of fiducial elements using the set of calibration images;
capturing a run time image of the locale or object, wherein the run time image does not include the selected fiducial element; and
identifying the location relative to the run time image using the run time image and the three-dimensional geometric model.

2. The method of claim 1, further comprising:
identifying a captured location relative to the run time image using the run time image and a second fiducial element in the set of fiducial elements; and
wherein the identifying of the location relative to the run time image uses the captured location.

3. The method of claim 2, wherein:
the set of fiducial elements are placed in the locale;
the locale is a studio, set, or performance venue;
the selected fiducial element is on-stage;
the second fiducial element is off-stage.

4. The method of claim 3, further comprising:
post processing the run time image to generate a scene image;
wherein the capturing of the run time image is conducted by a wide angle hero camera;
wherein the post processing includes cropping the run time image; and
wherein the run time image includes the second fiducial element.

5. The method of claim 3, further comprising:
capturing, while capturing the run time image, a run time assistance image using a witness camera;
wherein the run time image is a scene image captured by a hero camera;
wherein the identifying of the location relative to the run time image uses the run time assistance image, the run time image, and the three-dimensional geometric model;
wherein the run time assistance image includes the second fiducial element; and
wherein the run time image does not include the second fiducial element.

6. The method of claim 1, further comprising:
removing, after generating the three-dimensional geometric model and before capturing the run time image of the locale, the selected fiducial element from the locale or object;
testing the accuracy of the identifying step;
iteratively: (i) removing additional fiducials from the locale or object; (ii) capturing additional images of the locale or object; (ii) identifying the location using the three-dimensional geometric model and the additional images; and (iv) testing the accuracy of the additional iterations of the identifying step, until a sufficient subset of fiducial elements from the set of fiducial elements in the locale or on the object remain.

7. The method of claim 1, wherein:
the capturing of the set of calibration images is conducted using a depth sensor;
the set of calibration images are depth maps; and
the generating of the three-dimensional geometric model uses the depth maps.

8. The method of claim 1, wherein:
the capturing of the set of calibration images is conducted using a camera;
the fiducial elements in the set of fiducial elements comprise two-dimensional encodings; and
the generating of the three-dimensional geometric model uses pose information derived from the two-dimensional encodings.

9. The method of claim 8, further comprising:
deriving a bundle of pose information that includes pose information for each fiducial element in the set of fiducial elements; and
the generating of the three-dimensional geometric model uses the bundle of pose information for a global bundle adjustment the set of fiducial elements.

10. The method of claim 1, wherein:
removing the selected fiducial element from the locale after capturing the set of calibration images but prior to capturing the run time image; and
identifying a captured location relative to the run time image using the run time image and a second fiducial element in the set of fiducial elements;
wherein the captured location is a set of x and y coordinates in the run time image.

11. The method of claim 1, wherein:
the selected fiducial element is in the locale when the run time image is captured; and
the run time image does not include the selected fiducial element because the selected fiducial element is occluded.

12. The method of claim 1, wherein:
the set of fiducial elements consists of a set of anchor fiducial elements and a set of temporary fiducial elements;
the selected fiducial element is in the set of temporary fiducial elements;
the method further comprises removing the selected fiducial element from the locale after capturing the set of calibration images but prior to capturing the run time image; and
the placing step is conducted such that the set of anchor fiducial elements surround the set of temporary fiducial elements on at least two sides.

13. The method of claim 1, wherein:
the set of fiducial elements consists of a set of anchor fiducial elements and a set of temporary fiducial elements;
the selected fiducial element is in the set of temporary fiducial elements;
the method further comprises removing the selected fiducial element from the locale after capturing the set of calibration images but prior to capturing the run time image; and
the placing step is conducted such that the set of anchor fiducial elements are: (i) a set of four elements; (ii) non-colinear; and (iii) non-coplanar.

14. The method of claim 1, further comprising:
adding a visible virtual element to the run time image using the location to generate a modified image.

15. The method of claim 14, further comprising:
transmitting the modified image;
wherein the capturing of the run time image, identifying the location, adding the visible virtual element, and transmitting the modified image steps are executed as a real time process.

16. A method comprising:
placing a set of fiducial elements in a locale or on an object;
capturing a set of calibration images using an imager, wherein the set of fiducial elements is fully represented in the set of calibration images, and wherein the set of fiducial elements includes a set of anchor fiducial elements and a set of temporary fiducial elements;
generating a three-dimensional geometric model of the set of fiducial elements using the set of calibration images;
removing the set of temporary fiducial elements from the locale or object;
capturing, after removing the set of temporary fiducial elements, a second image of the locale or object, wherein the second image includes at least one anchor fiducial element from the set of anchor fiducial elements; and
identifying a set of locations previously occupied by the set of temporary fiducial elements using the second image and the three-dimensional geometric model.

17. The method of claim 16, further comprising:
post processing the second image to generate a scene image;
wherein the set of locations are identified in the second image;
wherein the capturing of the second image is conducted by a wide angle hero camera; and
wherein the post processing includes cropping the second image;

18. The method of claim 16, further comprising:
capturing, while capturing the second image with a witness camera, a scene image using a hero camera;
wherein the set of locations are identified in the scene image; and
wherein the scene image does not include any of the fiducial elements in the set of fiducial elements.

19. A method comprising:
placing a set of fiducial elements in a locale or on an object;
capturing a set of calibration images using an imager, wherein the set of fiducial elements is fully represented in the set of calibration images, and wherein a selected fiducial element in the set of fiducial elements is in a location;
generating a three-dimensional geometric model of the set of fiducial elements using the set of calibration images;
capturing, after generating the three-dimensional geometric model, a run time image of the locale or object, wherein the run time image does not include the selected fiducial element because the selected fiducial element is occluded; and
identifying the location relative to the run time image using the run time image and the three-dimensional geometric model.

20. The method of claim 19, further comprising:
adding a visible virtual element to the run time image using the location and an offset to generate a modified image.
